(19) United States
(12) Patent Application Publication
(10) Pub. No.: US 2019/0156133 A1
(43) Pub. Date: May 23, 2019

(54) VEHICLE DRIVING SUPPORT APPARATUS AND VEHICLE DRIVING SUPPORT PROGRAM

(71) Applicant: SHARP KABUSHIKI KAISHA, Osaka (JP)

(72) Inventors: SATORU KARAKI, Sakai City (JP); SAKAE SAITO, Sakai City (JP)

(21) Appl. No.: 16/147,728

(22) Filed: Sep. 29, 2018

(30) Foreign Application Priority Data
Nov. 20, 2017 (JP) 2017-222665

(51) Int. Cl. G06K 9/00; G06F 3/01; B60R 16/037

(52) U.S. Cl. CPC G06K 9/00845; B60R 16/037; G06F 3/013

(57) ABSTRACT

Visual line information unique to a driver is detected from a captured image of the driver, whose visual line is guided to a predetermined position, before starting driving, and visual line information of the driver detected during driving is calibrated by using the detected visual line information unique to the driver as a calibration value.

### BACKGROUND

### 1. Field

The present disclosure relates to a vehicle driving support apparatus and a vehicle driving support program.

### 2. Description of the Related Art

A vehicle driving support apparatus that detects a state of a driver and issues a warning of drowsy driving, inattentive driving, or the like has been known (for example, see Japanese Unexamined Patent Application Publication No. 10-244892 (published on Sep. 14, 1988)). The vehicle driving support apparatus described in Japanese Unexamined Patent Application Publication No. 10-244892 accumulates data of the driver during driving, detects the state of the driver by statistical method, and issues a warning of drowsy driving, inattentive driving, or the like to the driver. Further, a technique that estimates a visual line of the driver from an orientation of the face of the driver has also been known (for example, see Japanese Unexamined Patent Application Publication No. 2017-151694 (published on Aug. 31, 2017)).

However, the techniques as described above have a problem of not being able to detect the visual line of the driver with high quality from immediately after starting driving.

It is desirable to provide a technique that can detect the visual line of the driver with high quality from immediately after starting driving.

### SUMMARY

According to an aspect of the disclosure, there is provided a vehicle driving support apparatus including an image capturing unit that captures an image of a driver of a vehicle, a visual line detection unit that detects visual line information of the driver from the image captured by the image capturing unit, and a visual line guide unit that guides a visual line of the driver to a predetermined position before the driver starts driving. The visual line detection unit detects visual line information unique to the driver from the captured image of the driver whose visual line is guided to the predetermined position by the visual line guide unit and calibrates visual line information of the driver detected during driving by using the detected visual line information unique to the driver as a calibration value.

### BRIEF DESCRIPTION OF THE DRAWINGS

FIG. 1 is a block diagram illustrating an approximate configuration of a vehicle driving support apparatus according to Embodiment 1;

FIG. 2 is a schematic diagram illustrating an arrangement configuration of each unit of the vehicle driving support apparatus according to Embodiment 1;

FIGS. 3A to 3E are diagrams illustrating examples of captured images of the same driver captured by an image capturing unit;

FIGS. 4A and 4B are diagrams illustrating examples of captured images of different drivers captured by the image capturing unit;

FIG. 5 is a schematic diagram illustrating an arrangement configuration of each unit of a vehicle driving support apparatus according to Embodiment 2;

FIG. 6 is a schematic diagram illustrating an arrangement configuration of each unit of a vehicle driving support apparatus according to Embodiment 3;

FIG. 7 is a block diagram illustrating an approximate configuration of a vehicle driving support apparatus according to Embodiment 4; and

FIG. 8 is a schematic diagram illustrating an arrangement configuration of each unit of the vehicle driving support apparatus according to Embodiment 4.

### DESCRIPTION OF THE EMBODIMENTS

### Embodiment 1

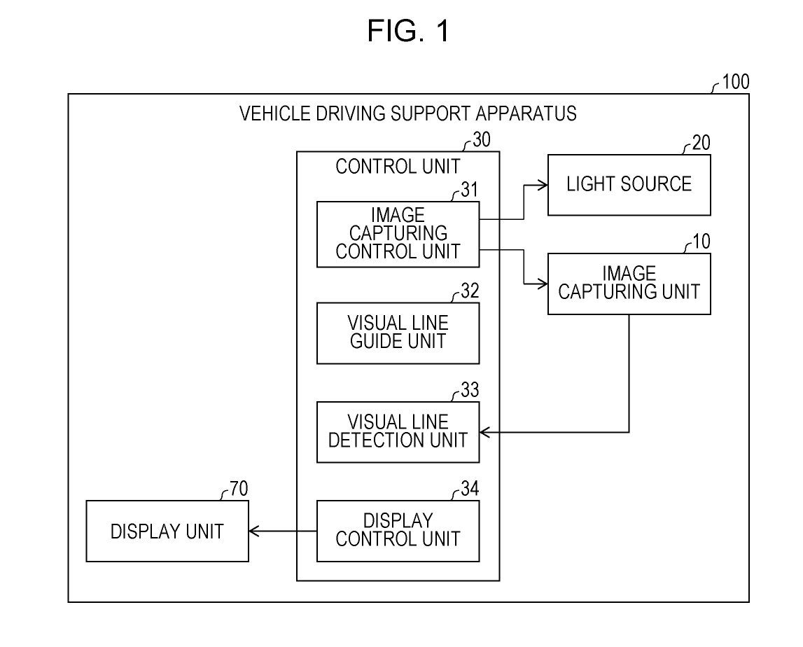

Hereinafter, Embodiment 1 of the present disclosure will be described in detail. FIG. 1 is a block diagram illustrating an approximate configuration of a vehicle driving support apparatus 100 according to Embodiment 1. The vehicle driving support apparatus 100 is an apparatus that detects a visual line of a driver of a vehicle to monitor whether the driver performs driving with a risk such as drowsy driving and inattentive driving.

### [Configuration of Vehicle Driving Support Apparatus 100]

As illustrated in FIG. 1, the vehicle driving support apparatus 100 includes a control unit 30, an image capturing unit 10, a light source 20, and a display unit 70. Each unit of the vehicle driving support apparatus 100 is appropriately arranged in the vehicle. Details of each unit of the vehicle driving support apparatus 100 will be described later.

The control unit 30 is an arithmetic device having a function to integrally control each unit of the vehicle driving support apparatus 100. The control unit 30 controls each component of the vehicle driving support apparatus 100 by using, for example, one or more processors (for example, CPU and the like) that execute a program stored in one or more memories (for example, RAM, ROM, and the like).

The image capturing unit 10 is, for example, a module where an image sensor such as CMOS or CCD is combined with a lens. The image capturing unit 10 may be mounted with a bandpass filter for separating wavelengths of light radiated from the light source 20 and ambient light. As the image sensor of the image capturing unit 10, an image sensor that can capture an image of wavelength of light emitted from the light source 20 is used.

The light source 20 is a light source for capturing an image of a driver of a vehicle by using the image capturing unit 10. The light source 20 emits light of near-infrared wavelength of 800 to 1000 nm, which causes no problem on the driver of the vehicle.

The display unit 70 is a display device that can display an image according to control of a display control unit 34 described later.

### [Configuration of Control Unit 30]

The control unit 30 includes an image capturing control unit 31, a visual line guide unit 32, a visual line detection unit 33, and a display control unit 34.

The image capturing control unit 31 controls light emission of the light source 20 and image capturing performed by the image capturing unit 10. The image capturing control unit 31 controls light emission of the light source 20 and causes light from the light source 20 to be emitted toward the driver of the vehicle, who is an object to be imaged, in particular toward eyeballs of the driver. The image capturing control unit 31 captures an image of the driver irradiated with the light from the light source 20, in particular an image of the eyeballs of the driver.

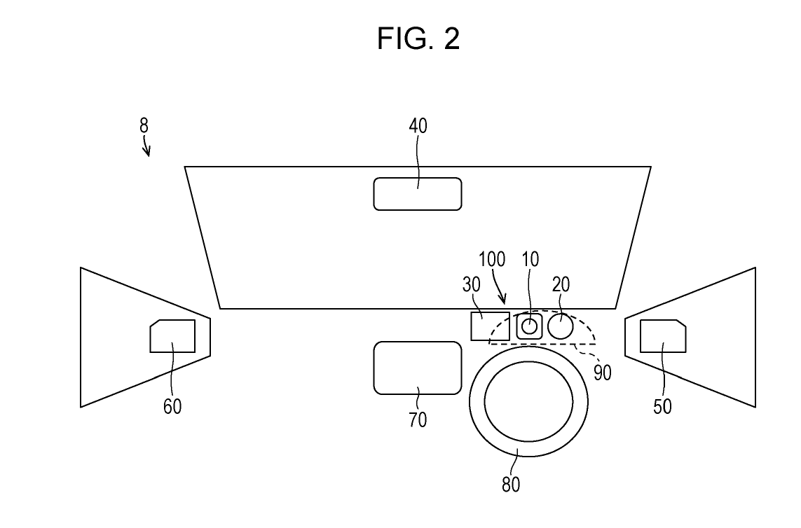

The visual line guide unit 32 guides a visual line of the driver to a predetermined position before the driver starts driving the vehicle. For example, the visual line guide unit 32 generates guidance information for guiding the visual line of the driver to a predetermined position. The guidance information is displayed on the display unit 70 by a function of the display control unit 34. The visual line guide unit 32 generates the guidance information for guiding the visual line of the driver, for example, to a meter panel unit 90, a rearview mirror unit 40, a right side mirror unit 50, a left side mirror unit 60, and the meter panel unit 90 (see FIG. 2) in this order.

The visual line detection unit 33 detects visual line information of the driver from an image captured by the image capturing unit 10. Although details will be described later, the visual line detection unit 33 detects visual line information unique to the driver from a captured image of the driver before starting driving whose visual line is guided to a predetermined position by the visual line guide unit 32. The visual line detection unit 33 defines the visual line information unique to the driver detected from the captured image of the driver before starting driving as an initial value of the visual line of the driver. The visual line detection unit 33 calibrates visual line information of the driver detected during driving by using the initial value of the visual line of the driver as a calibration value.

For example, the visual line detection unit 33 stores a moving amount of the visual line between guided positions of the visual line detected from captured images of the driver at the predetermined positions to which the visual line is guided by the visual line guide unit 32. Then, the visual line detection unit 33 calculates a visual line movement calibration value in a visual field of the driver (for example, 180 degrees) based on the moving amount of the visual line between the guided positions.

For example, the visual line detection unit 33 may calculate the calibration value by extrapolating the moving amounts of the visual line of the driver when the visual line is guided from the rearview mirror unit 40 to the left and right side mirror units 60 and 50. The visual line detection unit 33 improves determination quality by performing (correlating) determination of visual line movement based on the visual line movement calibration value that is a value including the extrapolation and applying the calibration value to the moving amount of the visual line during driving.

The display control unit 34 performs control of outputting, to the display unit 70, the guidance information generated by the visual line guide unit 32 for guiding the visual line of the driver to a predetermined position and displaying the guidance information on a display.

### [Arrangement Configuration of Each Unit in Vehicle]

FIG. 2 is a diagram schematically illustrating an arrangement configuration of each unit of the vehicle driving support apparatus 100 in the vehicle 8. As illustrated in FIG. 2, the vehicle 8 includes the meter panel unit 90 that is a portion for displaying a speedometer, an oil pressure, a battery voltage, and the other alerts, and a steering wheel device 80. Further, the vehicle 8 is provided with driving auxiliary devices including the rearview mirror unit 40, the right side mirror unit 50, the left side mirror unit 60, and the meter panel unit 90.

The meter panel unit 90 is arranged at a position lower than the face of the driver. The rearview mirror unit 40 is arranged at a position higher than the face of the driver. The right side mirror unit 50 is arranged at a position on the right side of the face of the driver. The left side mirror unit 60 is arranged at a position on the left side of the face of the driver.

It is desirable that the image capturing unit 10 is provided at a position facing the face of the driver who operates the steering wheel device 80. For example, the image capturing unit 10 can be arranged in the meter panel unit 90. In a configuration where the image capturing unit 10 is arranged in the meter panel unit 90, the image capturing unit 10 captures an image of the driver from below the face of the driver.

The light source 20 is provided in the vicinity of the image capturing unit 10 and emits light toward an image capturing target of the image capturing unit 10.

For example, the control unit 30 is arranged inside an instrument panel in the vicinity of the meter panel unit 90.

For example, the display unit 70 is provided in a center console.

### [Processing of Calculating Calibration Value]

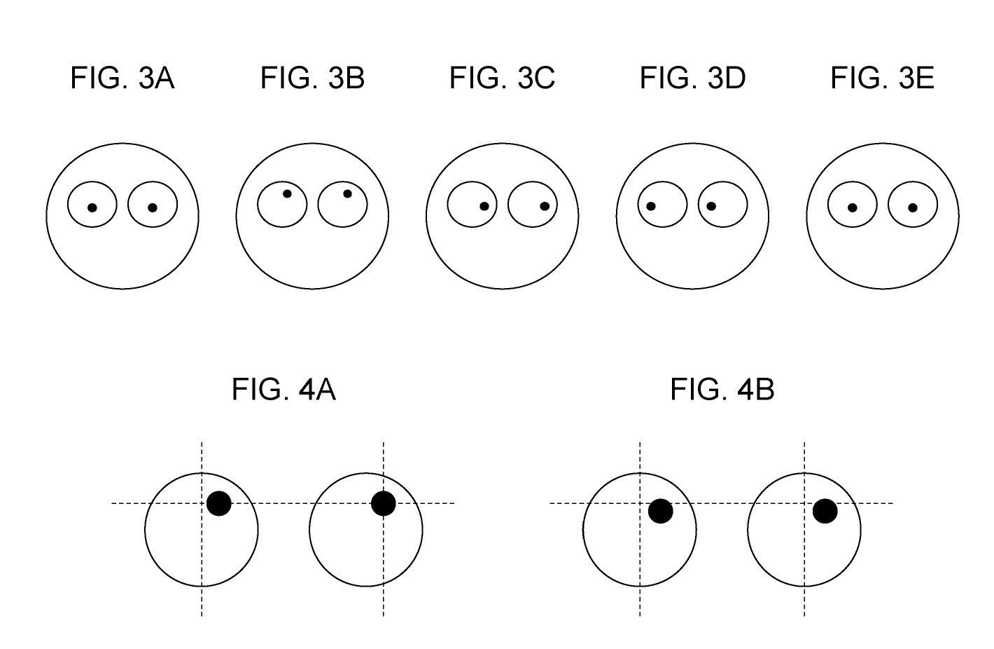

First, before the driver starts driving of the vehicle 8, the vehicle driving support apparatus 100 calculates the calibration value for calibrating the visual line information of the driver to be detected during driving. FIGS. 3A to 3E are diagrams illustrating examples of captured images of the same driver captured by the image capturing unit 10 when the calibration value is calculated. FIGS. 4A and 4B are diagrams illustrating examples of captured images of different drivers.

Before the driver starts driving, by a function of the visual line guide unit 32, the control unit 30 guides the visual line of the driver sequentially to a plurality of predetermined positions and instructs the driver to send the visual line to each position for a predetermined period of time (for example, a certain period of time from one second to ten seconds). For example, first, the visual line guide unit 32 guides the visual line of the driver to the meter panel unit 90. On this occasion, the image capturing control unit 31 causes the light source 20 to emit near-infrared light to the eyeballs of the driver and causes the image capturing unit 10 to capture an image of the driver. FIG. 3A illustrates an example of a captured image of the driver whose visual line is guided to the meter panel unit 90.

The visual line guide unit 32 second guides the visual line of the driver to the rearview mirror unit 40, third guides the visual line of the driver to the right side mirror unit 50, fourth guides the visual line of the driver to the left side mirror unit 60, and finally guides the visual line of the driver to the meter panel unit 90 to make a circular movement. After the visual line guide unit 32 has guided the visual line of the driver to all the guided positions, the visual line guide unit 32 may notify the driver that a visual line guiding operation is completed by information displayed on the display unit 70.

The image capturing control unit 31 causes the light source 20 to emit near-infrared light to the eyeballs of the driver at each guided position to which the visual line is guided by the visual line guide unit 32 and causes the image capturing unit 10 to capture an image of the driver.

FIG. 3B illustrates an example of a captured image of the driver whose visual line is guided to the rearview mirror unit 40. FIG. 3C illustrates an example of a captured image of the driver whose visual line is guided to the right side mirror unit 50. FIG. 3D illustrates an example of a captured image of the driver whose visual line is guided to the left side mirror unit 60. FIG. 3E illustrates an example of a captured image of the driver whose visual line is finally guided to the meter panel unit 90 again.

The visual line detection unit 33 detects visual line information including the orientation of left and right eyeballs of the driver and movement of the eyeballs from a captured image of the driver whose visual line is guided to each guided position. The positions of the meter panel unit 90, the rearview mirror unit 40, the right side mirror unit 50, and the left side mirror unit 60 are already known. Therefore, the visual line detection unit 33 detects the visual line information of the driver by referring to these positions and at least one of the orientation and the movement of the left and right eyeballs.

A series of operations where the driver sends the visual line to the meter panel unit 90, the rearview mirror unit 40, the right side mirror unit 50, and the left side mirror unit 60, and checks each unit are not unnatural as a normal inspection operation performed by the driver before the driver starts driving. Therefore, it is possible to detect the calibration value, which is the initial value of the visual line of the driver, without a load on the driver, because the visual line of the driver is guided to these predetermined positions by presenting the driver with a series of processes described above for detecting the visual line information of the driver before the driver starts driving as content to promote inspection before starting driving the vehicle, and the movement of the eyeballs during the inspection is detected as the visual line information.

The positions to which the visual line guide unit 32 guides the visual line of the driver may include the display unit 70 and the steering wheel device 80. The order in which the visual line guide unit 32 guides the visual line of the driver to a plurality of positions may be any order. The positions to which the visual line guide unit 32 guides the visual line of the driver may be displayed in an easy-to-understand manner by using any marks (for example, asterisks or the like).

The visual line detection unit 33 registers the movement of the eyeballs (the amount of movement of the eyeballs) unique to the driver which is the visual line information detected from images captured at respective guided position as the calibration value. The visual line detection unit 33 may calculate the calibration value unique to the driver by performing a series of processes described above every time before starting driving. The visual line detection unit 33 may have a configuration in which the visual line detection unit 33 stores the calibration value in association with the driver and identifies the driver from an image of the driver captured by the image capturing unit 10, and when the driver is a driver whose calibration value has already been stored, the visual line detection unit 33 uses the calibration value that has already been registered when starting driving for the second and subsequent times without calculating the calibration value again.

FIGS. 4A and 4B are diagrams illustrating examples of captured images of different drivers whose visual lines are guided to the rearview mirror unit 40. FIG. 4A illustrates visual line information of a certain driver and FIG. 4B illustrates visual line information of another driver. As illustrated in FIGS. 4A and 4B, the moving amount of the visual line when sending the visual line to each driving auxiliary device varies between respective drivers depending on the sitting height of the driver and the way the driver moves his or her head. Therefore, it is possible to detect the visual line information of the driver with higher quality by using the visual line information unique to the driver as the calibration value.

Even for the same driver, the moving amount of the visual line when sending the visual line to each driving auxiliary device may vary between respective driving occasions depending on the seat setting position, the manner to sit on the seat, and the like. Therefore, the control unit 30 calculates the calibration value every time before starting driving, and thus it is possible to detect the visual line of the driver with higher quality.

The visual line guide unit 32 may guide the visual line of the driver to predetermined positions such as the meter panel unit 90, the rearview mirror unit 40, the right side mirror unit 50, and the left side mirror unit 60 by presenting guidance information having content to prompt the driver to adjust the front/back position and the height position of the seat before the driver drives the vehicle. The visual line detection unit 33 may have a configuration to detect the movement of the eyeballs when the driver adjusts the position of the seat as the visual line information and define the visual line information as the calibration value which is the initial value of the visual line of the driver.

The visual line guide unit 32 may guide the visual line of the driver to predetermined positions by presenting guidance information having content to prompt the driver to adjust the positions of the rearview mirror unit 40 and the left and right side mirror units 60 and 50 before the driver drives the vehicle. The visual line detection unit 33 may have a configuration to detect the movement of the eyeballs when the driver adjusts the position of the rearview mirror unit 40 and the left and right side mirror units 60 and 50 as the visual line information and define the visual line information as the calibration value which is the initial value of the visual line of the driver.

The control unit 30 may have a configuration to store the calibration value which is the initial value of the visual line of each driver, for each of a plurality of drivers and accumulate the visual line information detected by a function of the visual line detection unit 33 during driving of each driver. The control unit 30 may analyze tendency of the visual line of each driver by referring to the accumulated visual line information of the drivers and provide information such as an advice for safe driving based on a result of the analysis. The visual line information is accumulated for each of a plurality of drivers, and thus the owner of the vehicle 8 is able to know the manner in which another driver drives the vehicle 8 by reviewing the visual line information when the owner lends the vehicle 8 to a family member or a friend or when the owner causes another driver to drive the vehicle 8.

By causing the vehicle driving support apparatus 100 to cooperate with a navigation system, locations where safety support is desired, such as a location where inattentive driving tends to be performed, a location where visibility is poor, and a location where accidents frequently occur are specified on a map, and when the vehicle approaches such locations, the visual line information of the driver may be detected and information such as advice for appropriate safe driving may be provided.

As described above, in the vehicle driving support apparatus 100, the visual line information unique to the driver is detected from a captured image of the driver before starting driving whose visual line is guided to a predetermined position by the visual line guide unit 32, and the detected visual line information unique to the driver is defined as the initial value of the visual line of the driver. Then, the visual line detection unit 33 calibrates visual line information of the driver detected during driving by using the initial value of the visual line of the driver as a calibration value. Thereby, the initial value unique to the driver can be correctly acquired. Further, by calibrating the visual line information of the driver detected during driving by using the initial value unique to the driver as the calibration value, the amount of calculation of the visual line during driving is reduced, and it is possible to detect the visual line information of the driver with high quality from immediately after the start of the driving. Therefore, it is possible to provide high quality driver information to the driver from immediately after the start of the driving.

Further, the visual line information of the driver can be detected with high quality, and thus it is possible to perform accident analysis such as whether the driver performs inattentive driving by analyzing the visual line information of the driver when the driver caused a traffic accident. Further, the visual line information of the driver can be detected with high quality, and thus it is possible to analyze a driving state of the driver such as drowsy driving. Therefore, it is possible to provide information such as an advice for safe driving.

For example, when the visual line detection unit 33 detects that the visual line of the driver shifts from the front while driving on an expressway, it is possible to analyze the driving state of the driver such that the posture of the driver changes due to fatigue. Further, for example, when the visual line detection unit 33 detects that the visual line of the driver is unstable during driving, it is possible to analyze the driving state of the driver such that the driver is irritated. Then, it is possible to finely support safe driving such as issuing a warning of inattentive driving and an announcement for prompting a break based on an analysis result of the driving state of the driver.

### Embodiment 2

Embodiment 2 of the present disclosure will be described below. For convenience of description, members having the same functions as those described in the above embodiment will be denoted by the same reference numerals, and the description thereof will not be repeated. Further, an approximate configuration of a vehicle driving support apparatus 200 according to Embodiment 2 is the same as that of the vehicle driving support apparatus 100 illustrated in FIG. 1, and therefore the description thereof will be omitted.

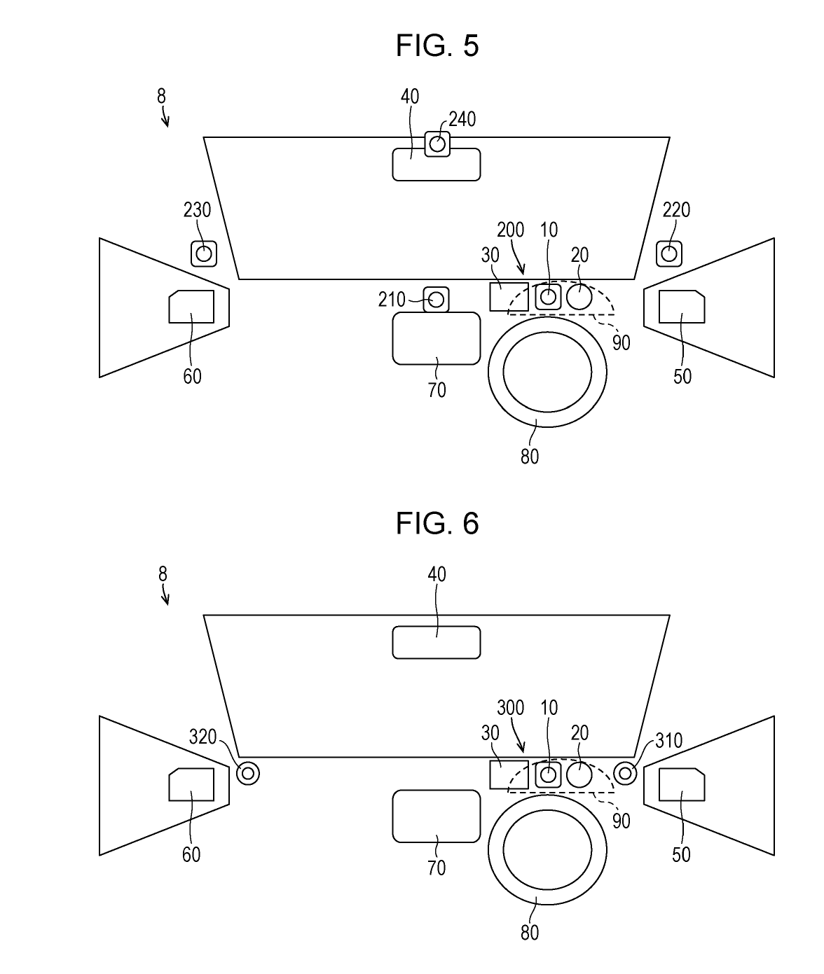

FIG. 5 is a diagram schematically illustrating an arrangement configuration of each unit of the vehicle driving support apparatus 200 in the vehicle 8.

As illustrated in FIG. 5, the vehicle driving support apparatus 200 is different from the vehicle driving support apparatus 100 of Embodiment 1 in that the image capturing unit includes a plurality of imaging units 10, 210, 220, and 230.

The vehicle driving support apparatus 200 includes, for example, the imaging unit 210 arranged in an upper portion of the display unit 70, the imaging unit 220 arranged in an upper portion (pillar portion) of the right side mirror unit 50, the imaging unit 230 arranged in an upper portion (pillar portion) of the left side mirror unit 60, and the imaging unit 240 arranged on the rearview mirror unit 40, in addition to the imaging unit 10 arranged at a position facing the driver.

Therefore, it is possible to capture an image of the driver from various angles as compared with capturing an image of the driver by the imaging unit 10. Each of the plurality of imaging units 10, 210, 220, 230, and 240 may be provided at a position from which an image of the driver can be captured. The installation positions of the imaging units and the number of the imaging units to be installed are not limited to the positions and the number described above.

The image capturing control unit 31 performs control so that the plurality of imaging units 10, 210, 220, 230, and 240 perform image capturing operations in synchronization with each other.

The visual line detection unit 33 can detect visual line information unique to the driver by using images captured from different angles, which are captured at the same timing by each of the plurality of imaging units 10, 210, 220, 230, and 240. Therefore, the calibration value can be obtained with a higher degree of accuracy and it is possible to detect the visual line information of the driver with high quality.

### Embodiment 3

Embodiment 3 of the present disclosure will be described below. For convenience of description, members having the same functions as those described in the above embodiments will be denoted by the same reference numerals, and the description thereof will not be repeated. Further, an approximate configuration of a vehicle driving support apparatus 300 according to Embodiment 3 is the same as that of the vehicle driving support apparatus 100 illustrated in FIG. 1, and thus the description thereof will be omitted.

FIG. 6 is a diagram schematically illustrating an arrangement configuration of each unit of the vehicle driving support apparatus 300 in the vehicle 8.

As illustrated in FIG. 6, the vehicle driving support apparatus 300 is different from the vehicle driving support apparatus 100 of Embodiment 1 in that a right speaker unit 310 and a left speaker unit 320, which are audio output units, are included.

The visual line guide unit 32 guides the visual line of the driver to a predetermined position by at least one of guiding methods, which are a method of guiding the visual line of the driver to the predetermined position by guidance information displayed on the display unit 70 and a method of guiding the visual line of the driver to the predetermined position by audio guidance outputted from the left and right speaker units 320 and 310. In the method of guiding the visual line of the driver to the predetermined position by the guidance information displayed on the display unit 70, the driver has to check the display on the display unit 70 in order to check a position to which the driver sends the visual line next time after sending the visual line to the predetermined position. On the other hand, in the method of guiding the visual line of the driver to the predetermined position by the audio guidance outputted from the left and right speaker units 320 and 310, the driver can send the visual line to the predetermined position according to the audio guidance without checking the display on the display unit 70. It is possible to reduce a time required for a series of operations to guide the visual line of the driver to a plurality of positions by employing the method of guiding the visual line of the driver to a predetermined position by the audio guidance outputted from the left and right speaker units 320 and 310. Therefore, it is possible to calculate the calibration value for calibrating the visual line information in a shorter period of time before the driver starts driving.

Although not shown in the drawings, a pilot lamp may be installed in the vicinity of respective visual line guided positions such as the image capturing unit 10, the rearview mirror unit 40, the left and right side mirror units 60 and 50, and the meter panel unit 90. The visual line guide unit 32 may guide the visual line of the driver by sequentially turning on the pilot lamps. In this way, it is possible to more reliably guide the visual line of the driver to a predetermined position by using lighting of the pilot lamps in combination with at least one of the guidance information displayed on the display unit 70 and the audio guidance outputted from the left and right speaker units 320 and 310.

### Embodiment 4

Embodiment 4 of the present disclosure will be described below. For convenience of description, members having the same functions as those described in the above embodiments will be denoted by the same reference numerals, and the description thereof will not be repeated.

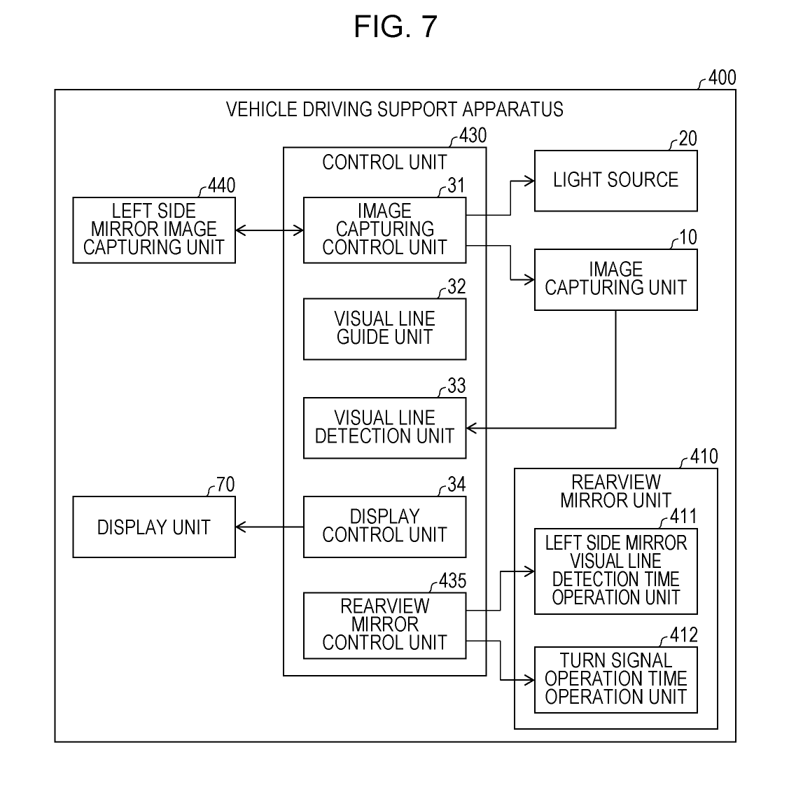

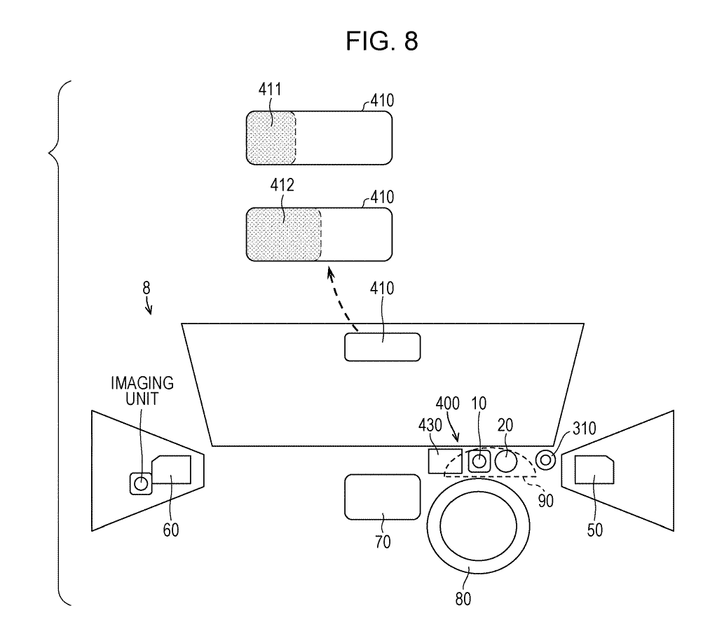

FIG. 7 is a block diagram illustrating an approximate configuration of a vehicle driving support apparatus 400. FIG. 8 is a diagram schematically illustrating an arrangement configuration of each unit of the vehicle driving support apparatus 400 in the vehicle 8.

As illustrated in FIGS. 7 and 8, the vehicle driving support apparatus 400 is different from the vehicle driving support apparatus 100 of Embodiment 1 in that a rearview mirror unit 410 and a left side mirror image capturing unit 440 are included and a control unit 430 includes a rearview mirror control unit 435.

The control unit 430 controls operations of a left side mirror visual line detection time operation unit 411 and a turn signal operation time operation unit 412, which are described later, of the rearview mirror unit 410 by a function of the rearview mirror control unit 435.

In the same manner as the image capturing unit 10, the left side mirror image capturing unit 440 is a module where an image sensor such as CMOS or CCD is combined with a lens. The left side mirror image capturing unit 440 captures the same image as a mirror image reflected on the left side mirror unit 60 in accordance with control of the image capturing control unit 31.

In a vehicle where the steering wheel device 80 is arranged on the left side in the traveling direction of the vehicle 8, it is desirable that, instead of the left side mirror image capturing unit 440, an image capturing unit is provided in the vicinity of the right side mirror unit 50.

The rearview mirror unit 410 includes the left side mirror visual line detection time operation unit 411 and the turn signal operation time operation unit 412. The left side mirror visual line detection time operation unit 411 and the turn signal operation time operation unit 412 are display devices such as, for example, liquid crystal display devices, which are built in the rearview mirror unit 410. The left side mirror visual line detection time operation unit 411 and the turn signal operation time operation unit 412 can display an image in accordance with control of the rearview mirror control unit 435.

### (Operation of Vehicle Driving Support Apparatus 400)

In the same manner as the vehicle driving support apparatus 100 described in Embodiment 1, the vehicle driving support apparatus 400 performs a series of operations that detect the visual line information unique to the driver as the calibration value. While the driver is driving the vehicle 8, the visual line information of the driver during driving is detected with high quality by using the calibration value calculated before driving.

When the control unit 430 detects that the driver who is driving the vehicle 8 sends the visual line to the left side mirror unit 60 for a predetermined period of time (for example, from one second to three seconds) by a function of the visual line detection unit 33, the control unit 430 acquires a captured image of the left side mirror image capturing unit 440 by a function of the image capturing control unit 31. The control unit 430 displays the captured image of the left side mirror image capturing unit 440 on the left side mirror visual line detection time operation unit 411, which is a part of the rearview mirror unit 410, by a function of the rearview mirror control unit 435. The rearview mirror control unit 435 keeps a display operation of the captured image of the left side mirror image capturing unit 440 on the left side mirror visual line detection time operation unit 411 for a predetermined period of time (for example, from one second to ten seconds).

In this way, it is possible to capture the same image as the mirror image on the left side mirror unit 60 by the left side mirror image capturing unit 440 and display the captured image on at least a part of the rearview mirror unit 410. Therefore, it is possible to check information in the left side direction and the left rear direction, which is far from the driver and difficult for the driver to check, by the image which is captured by the left side mirror image capturing unit 440 and displayed on the rearview mirror unit 410, and thus the safety of driving is improved.

When the driver operates a turn signal for changing the lane to the left, the control unit 430 displays the captured image of the left side mirror image capturing unit 440 on the turn signal operation time operation unit 412 which is a part of the rearview mirror unit 410. As illustrated in FIG. 8, the turn signal operation time operation unit 412 has a display area larger than the left side mirror visual line detection time operation unit 411.

According to this configuration, when changing the lane to the left, it is possible to check the information in the left side direction and the left rear direction, which is far from the driver and difficult for the driver to check, by the image which is captured by the left side mirror image capturing unit 440 and displayed on the turn signal operation time operation unit 412. Therefore, the driver can easily check information on the lane to which the vehicle moves, and thus the driver can change lanes and cause the vehicle to curve more safely.

The captured image of the left side mirror image capturing unit 440 may be displayed on the turn signal operation time operation unit 412 after the visual line detection unit 33 detects that the driver sends the visual line to the left side mirror unit 60 for a predetermined period of time (for example, from one second to three seconds). Thereby, it is possible to check that the driver tries to change the lane to the left after properly checking the left side mirror unit 60, and thus it is possible to appropriately support safe driving.

### [Implementation Example by Software]

A control block (including in particular, the image capturing control unit 31, the visual line guide unit 32, the visual line detection unit 33, and the display control unit 34) of the vehicle driving support apparatus 100 may be implemented by a logic circuit (hardware) formed on an integrated circuit (IC chip) or the like or may be implemented by software.

When the control block is implemented by software, the vehicle driving support apparatus 100 includes a computer that executes commands of a program which is software that implements each function. For example, the computer includes at least one processor (control device) and at least one computer-readable recording medium that stores the program. An object of the present disclosure is achieved when the processor reads the program from the recording medium and executes the program in the computer. As the processor, for example, it is possible to use a central processing unit (CPU). As the recording medium, a “non-transitory tangible medium”, for example, a read only memory (ROM), a tape, a disk, a card, a semiconductor memory, a programmable logic circuit, or the like can be used. A random access memory (RAM) where the program is expanded may be further included. The program may be supplied to the computer through any transmission medium (communication network, broadcast wave, or the like) that can transmit the program. An aspect of the present disclosure can be implemented in a form of a data signal embedded in a carrier wave, where the program is embodied by electronic transmission.

### [Conclusion]

A vehicle driving support apparatus (100) according to an aspect 1 of the present disclosure is configured to include an image capturing unit (10) that captures an image of a driver of a vehicle (8), a visual line detection unit (33) that detects visual line information of the driver from the image captured by the image capturing unit (10), and a visual line guide unit (32) that guides a visual line of the driver to a predetermined position before the driver starts driving. The visual line detection unit (33) detects visual line information unique to the driver from the captured image of the driver whose visual line is guided to the predetermined position by the visual line guide unit (32) and calibrates visual line information of the driver detected during driving by using the detected visual line information unique to the driver as a calibration value.

According to the above configuration, the calibration value is calculated before starting driving, and the visual line information of the driver detected during driving is calibrated by using the calculated calibration value, and thus it is possible to detect the visual line of the driver with high quality from immediately after starting driving.

The vehicle driving support apparatus (100) according to an aspect 2 of the present disclosure may be configured in the aspect 1 described above so that the visual line guide unit (32) guides the visual line of the driver to driving auxiliary devices including a rearview mirror unit (40), side mirror units (50 and 60), a display unit (70), and a meter panel unit (90) in the vehicle (8).

According to the above configuration, the calibration value is calculated by guiding the visual line of the driver to each of the driving auxiliary devices which the driver visually checks during driving, and thus it is possible to calculate the calibration value unique to the driver with high accuracy. Therefore, it is possible to detect the visual line of the driver with high quality from immediately after starting driving.

The vehicle driving support apparatus (100) according to an aspect 3 of the present disclosure may be configured in the aspect 1 or 2 described above to include a light source (20) that emits near-infrared light toward eyeballs of the driver, and the image capturing unit (10) includes an image sensor that can capture an image of near-infrared wavelength.

According to the above configuration, it is possible to emits light of the light source (20) toward the eyeballs of the driver and capture an image of the eyeballs without disturbing driving of the driver, and thus movement of the eyeballs and the amount of the movement can be correctly detected.

A vehicle driving support apparatus (200) according to an aspect 4 of the present disclosure may be configured in any one of the aspects 1 to 3 described above so that the image capturing unit (10) includes a plurality of imaging units (10, 210, 220, 230, and 240) arranged respectively at positions where an image of the driver can be captured.

According to the above configuration, it is possible to detect visual line information unique to the driver by using images captured from different angles. Therefore, the calibration value can be obtained with a higher degree of accuracy, and it is possible to detect the visual line of the driver with high quality from immediately after starting driving.

The vehicle driving support apparatus (200) according to an aspect 5 of the present disclosure may be configured in the aspect 4 described above so that the plurality of imaging units (10, 210, 220, 230, and 240) operate in synchronization with each other.

According to the above configuration, it is possible to detect the visual line information unique to the driver by using images that are captured at the same timing from different angles, so that it is possible to detect the visual line of the driver with high quality from immediately after starting driving.

A vehicle driving support apparatus according to an aspect 6 of the present disclosure may be configured in any one of the aspects 2 to 5 described above so that the visual line guide unit guides the visual line of the driver to a predetermined position by guidance information displayed on the display unit.

According to the above configuration, it is possible to guide the visual line of the driver to a predetermined position in an easy-to-understand manner for the driver.

A vehicle driving support apparatus according to an aspect 7 of the present disclosure may be configured in any one of the aspects 1 to 6 described above so that the visual line guide unit guides the visual line of the driver to a predetermined position by audio guidance outputted through an audio output unit.

According to the above configuration, it is possible to guide the visual line of the driver to a predetermined position in an easy-to-understand manner for the driver. Further, when guiding the visual line of the driver to a plurality of positions, a guide time can be reduced and it is possible to reduce a time of calculation operation of the calibration value before starting driving.

The vehicle driving support apparatus (100) according to an aspect 8 of the present disclosure may be configured in any one of the aspects 1 to 7 described above so that the visual line guide unit (32) guides the visual line of the driver to a predetermined position by presenting content for promoting at least one of inspection before starting driving a vehicle and adjustment of seat, and the visual line detection unit detects movement of eyeballs during at least one of the inspection and the adjustment of seat by the driver as the visual line information and uses the detected visual line information as the calibration value.

According to the above configurations, the calibration value can be obtained with a higher degree of accuracy, and it is possible to detect the visual line of the driver with high quality from immediately after starting driving.

The vehicle driving support apparatus according to each aspect of the present disclosure may be implemented by a computer. In this case, a control program of a vehicle driving support apparatus that implements the vehicle driving support apparatus by a computer by causing the computer to operate as each unit (software element) included in the vehicle driving support apparatus and a computer-readable recording medium that stores the control program are included in a category of the present disclosure.

The present disclosure is not limited to the embodiments described above, but can be variously modified within the scope of the claims. An embodiment obtained by appropriately combining technical units disclosed in different embodiments is also included in the technical scope of the present disclosure. Further, it is possible to form novel technical features by combining the technical units disclosed respectively in the embodiments.

The present disclosure contains subject matter related to that disclosed in Japanese Priority Patent Application JP 2017-222665 filed in the Japan Patent Office on Nov. 20, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A vehicle driving support apparatus comprising:
an image capturing unit that captures an image of a driver of a vehicle;
a visual line detection unit that detects visual line information of the driver from the image captured by the image capturing unit; and
a visual line guide unit that guides a visual line of the driver to a predetermined position before the driver starts driving,
wherein the visual line detection unit detects visual line information unique to the driver from the captured image of the driver whose visual line is guided to the predetermined position by the visual line guide unit and calibrates visual line information of the driver detected during driving by using the detected visual line information unique to the driver as a calibration value.

2. The vehicle driving support apparatus according to claim 1, wherein the visual line guide unit guides the visual line of the driver to driving auxiliary devices including a rearview mirror unit, side mirror units, a display unit, and a meter panel unit in the vehicle.

3. The vehicle driving support apparatus according to claim 1, further comprising:
a light source that emits near-infrared light toward eyeballs of the driver,
wherein the image capturing unit includes an image sensor that can capture an image of near-infrared wavelength.

4. The vehicle driving support apparatus according to claim 1, wherein the image capturing unit includes a plurality of imaging units arranged respectively at positions where an image of the driver is captured.

5. The vehicle driving support apparatus according to claim 4, wherein the plurality of imaging units operate in synchronization with each other.

6. The vehicle driving support apparatus according to claim 2, wherein the visual line guide unit guides the visual line of the driver to the predetermined position by guidance information displayed on the display unit.

7. The vehicle driving support apparatus according to claim 1, wherein the visual line guide unit guides the visual line of the driver to the predetermined position by audio guidance outputted through an audio output unit.

8. The vehicle driving support apparatus according to claim 1, wherein
the visual line guide unit guides the visual line of the driver to the predetermined position by presenting content for promoting at least one of inspection before starting driving a vehicle and adjustment of seat, and
the visual line detection unit detects movement of eyeballs during at least one of the inspection and the adjustment of seat by the driver as the visual line information and uses the detected visual line information as the calibration value.

9. A vehicle driving support program for causing a computer to function as the vehicle driving support apparatus according to claim 1, wherein
the vehicle driving support program causes a computer to function as the visual line detection unit and the visual line guide unit.
